(19) United States
(12) Patent Application Publication
(10) Pub. No.: US 2014/0244680 A1
(43) Pub. Date: Aug. 28, 2014

(54) SQL QUERY PARSING AND TRANSLATION

(71) Applicants: LAKSHMY CHANDRAN, Bangalore (IN); Venkatram Vundavalli, Bangalore (IN)

(72) Inventors: LAKSHMY CHANDRAN, Bangalore (IN); Venkatram Vundavalli, Bangalore (IN)

(21) Appl. No.: 13/779,748

(22) Filed: Feb. 28, 2013

(51) Int. Cl. G06F 17/30

(52) U.S. Cl. CPC G06F 17/30427
USPC 707/760

(57) ABSTRACT

Various embodiments of systems and methods of translating SQL queries are described herein. A structured query language (SQL) query of a first database is split into tokens and traversed from a first token. When a keyword token is encountered, a current parser is created to store a table name and a column name associated with the encountered keyword token. When an open parenthesis is encountered, a token immediately preceding the open parenthesis is stored as a function name in the current parser. The table names, column names, and function names of a plurality of parsers are consolidated. One or more of the table names, the column names, and the function names are replaced with corresponding names that are compatible with SQL-syntax of a second database. A result comprising the consolidated table names, the consolidated column names, the consolidated function names, and replaced names is generated.

### BACKGROUND

Structured Query Language (SQL) is a language for accessing and manipulating databases. Due to various reasons such as technological improvements and change of vendors, there may be a need to migrate from an existing database to a new database. An existing database can use database views, stored procedures, custom functions, etc., which have SQL scripts. An SQL script is a set of SQL commands. The SQL scripts refer to one or more database columns, tables, and database specific functions. However, there can be variations in syntax, keywords, and other elements of SQL between different types of databases. For example, the existing database may be case insensitive and queries with table names, column names, and database functions can be written in any case. But the new database may be case sensitive. Also, database-specific functions differ from one database to another. A database administrator needs to inspect the query and replace the database-specific functions. Therefore, the queries of an existing database cannot be readily used in the new database and significant manual effort is required to translate the queries for compatibility with the new database.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating databases and associated SQL queries, according to one embodiment.

FIG. 2 is a flow diagram of SQL query parsing and translation, according to one embodiment.

FIG. 3 is a flow diagram illustrating creation of parsers to store table and column names, according to one embodiment.

FIG. 4 is a flow diagram illustrating a procedure related to function names, according to one embodiment.

FIG. 5 is a flow diagram illustrating a procedure related to reserved tokens and operators, according to one embodiment.

FIG. 6 is a block diagram illustrating consolidation of data from a plurality of parsers, according to one embodiment.

FIG. 7 is a block diagram illustrating consolidation of data from a plurality of parsers of a nested query, according to one embodiment.

FIG. 8 is a block diagram illustrating a user interface of a query parsing and translation application, according to one embodiment.

FIG. 9 is a block diagram illustrating a user interface of a query parsing and translation application showing query insights, according to one embodiment.

FIG. 10 is a block diagram illustrating a user interface of a query parsing and translation application showing translated query, according to one embodiment.

FIG. 11 is a block diagram of an exemplary computer system according to one embodiment.

### DETAILED DESCRIPTION

Embodiments of techniques for SQL query parsing and translation are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

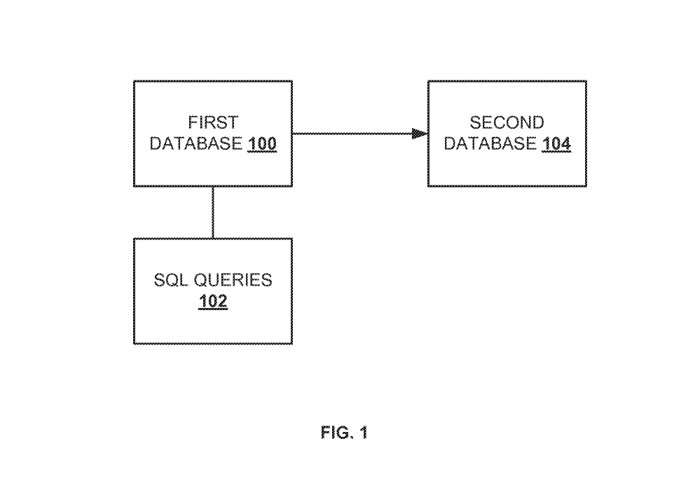

There can be several types of databases for storing data. SQL is a language used for accessing and managing data in databases. Although there are some standard SQL commands such as “SELECT,” “INSERT,” and “UPDATE,” there may be a variation in SQL syntax depending on the type of database. A particular database typically has a set of SQL queries, e.g., in the form of SQL scripts, which are compatible with the syntax of that database. For example, referring to FIG. 1, a first database 100 has a set of SQL queries 102 that are created for the first database 100. Some situations require migration from one database to another, e.g., from first database 100 to a second database 104. As an example, the first database 100 can be a particular type of relational database management system and a second database 104 can be another type of relational database or an in-memory database. The SQL syntax of the second database 104 can be different from that of the first database 100. Therefore, the SQL queries 102 of the first database 100 cannot be readily used in the second database 104. The embodiments described below facilitate migration by parsing and translating SQL queries 102 of the first database 100 for compatibility with the second database 104.

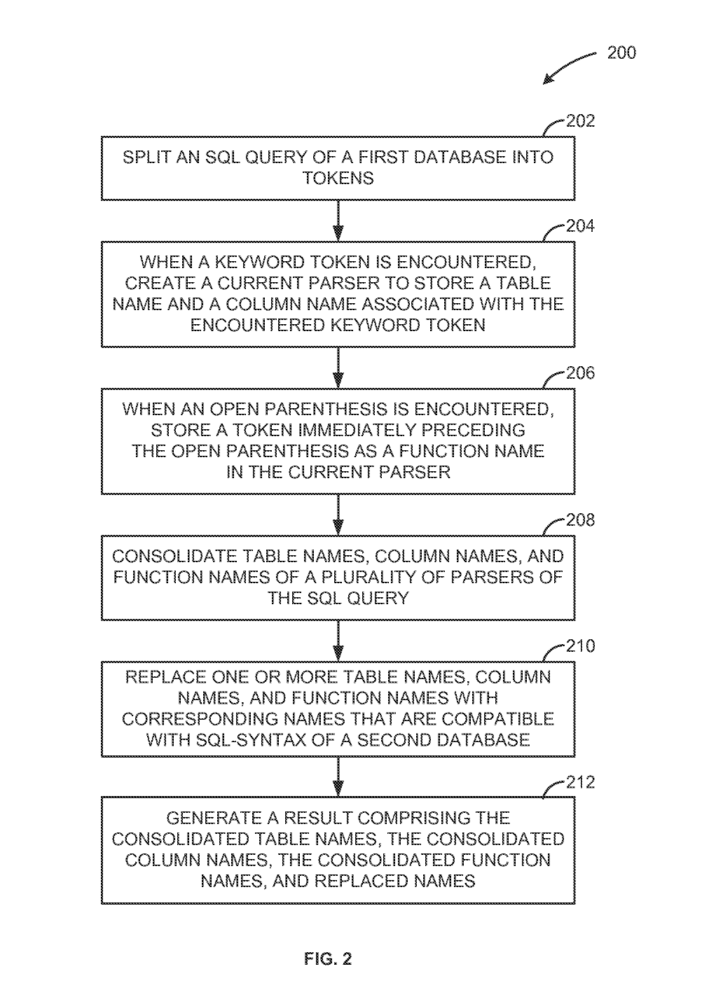

FIG. 2 illustrates an embodiment 200 of SQL query parsing and translation. An SQL query of a first database is first read. At 202, the SQL query is split into a plurality of tokens. A basic syntactical unit of the SQL language is called a token. A token includes one or more characters. The tokens include keywords such as SELECT, INSERT, UPDATE, FROM, WHERE, etc. parentheses, operators, table names, column names, alias names, functions, and reserved tokens such as JOIN, INNER, and OUTER. In one embodiment, the tokens do not include blanks, control characters, and characters within a string constant or a delimited identifier. As an example the following SQL query is considered in explaining the embodiments of parsing and translation.

SELECT Count(1), CITY.CITY_NAME AS City,
COUNTRY.COUNTRY_NAME AS Country
FROM CITY AS CT, COUNTRY AS CY
WHERE CITY.COUNTRY_ID = COUNTRY.COUNTRY_ID

The above SQL query is split into tokens based on the blank spaces, open parenthesis “(“, closed parenthesis”)”, and comma “,”. The following table presents a list of some of the tokens that are obtained after splitting the query:

TABLE 1
SELECT
Count
(
1
)
CITY.CITY_NAME
AS
City
COUNTRY.COUNTRY_NAME
AS
Country
FROM
CITY
CT
COUNTRY
CY
WHERE
CITY.COUNTRY_ID
=
COUNTRY.COUNTRY_ID

Once the query is tokenized, the query is traversed from a first token. In the above example, the first token is “SELECT”. At 204, when a keyword token is encountered, a current parser is created for that keyword token to store table names and column names associated with the keyword token. A parser is a class for storing entities associated with a keyword. The entities associated with a keyword include table names, column name, reserved tokens, and operators. In the above example, CITY and COUNTRY are the table names associated with the SELECT token and CITY_NAME and COUNTRY_NAME are the column names associated with the SELECT token. Therefore, when the SELECT token is encountered, a SELECT parser is created to store CITY, COUNTRY, CITY_NAME, and COUNTRY_NAME.

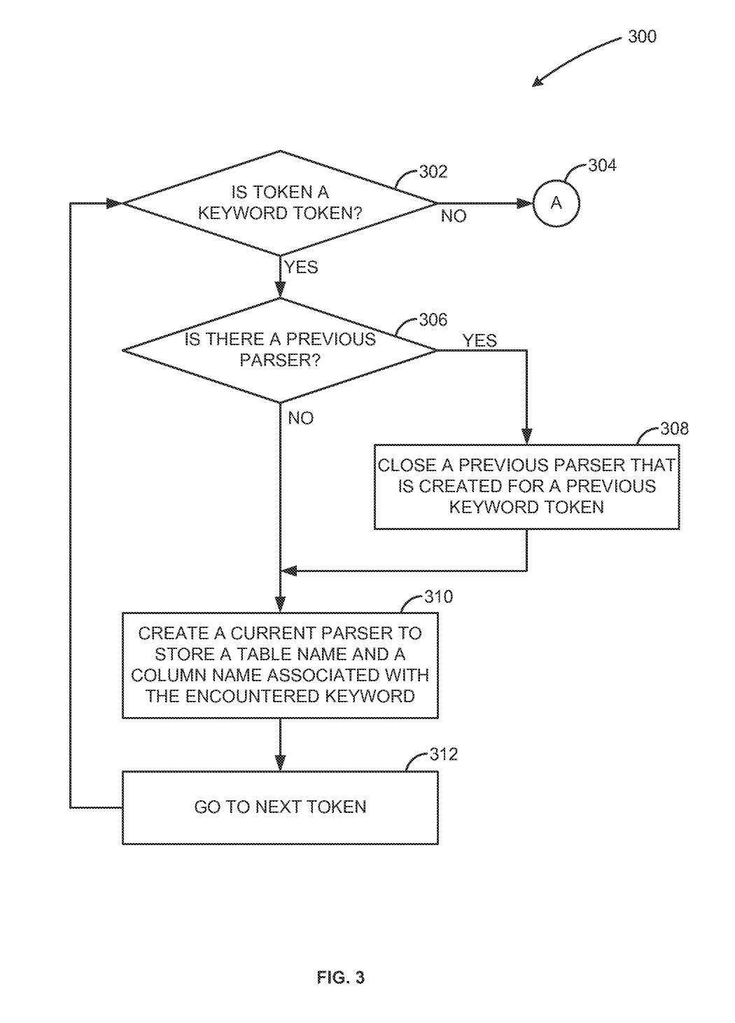

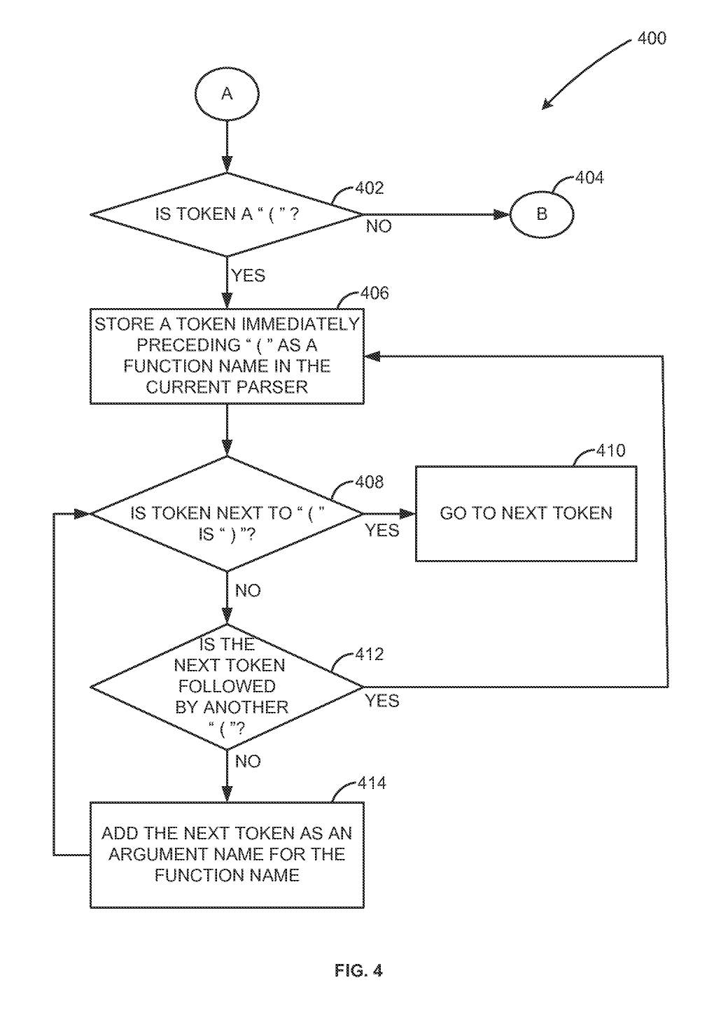

An embodiment of a procedure 300 of creation of parsers and storing of table and column names is illustrated in FIG. 3. When a token is encountered in the process of traversing a query, initially a determination of whether a token is a keyword is made at 302. When the token is not a keyword, at 304 a subsequent procedure is used to determine the type of the token, as will be explained in reference to FIG. 4. When the token is a keyword, then a determination is made at 306 whether there is any previous parser. The previous parser, if any, is created for a previously encountered keyword token. If there is a previous parser, then the previous parser is closed at 308. A current parser is then created at 310 to store table names and column names associated with the currently encountered token. Taking the above SQL query, the SELECT parser is first created and when the FROM keyword is encountered, a determination is a made whether there is any previous parser. The SELECT parser is the previous parser in this situation. Therefore, the SELECT parser is closed. The FROM parser is then created at 310 to store table names and column names associated with the FROM token. After the current parser is created, query traversing process moves to next token 312 and starts from step 302.

Referring back to FIG. 2, at 206, when an open parenthesis is encountered, a token immediately preceding the open parenthesis is stored as a function name in the current parser. Each database can have its own specific functions with compatible syntax. For example, the function “COUNT (1)” is specific to the first database. After the SELECT parser is created, the query is traversed and when the open parenthesis “(” is encountered, then the “COUNT” token that is immediately before the open parenthesis “(” is stored as a function name in the SELECT parser.

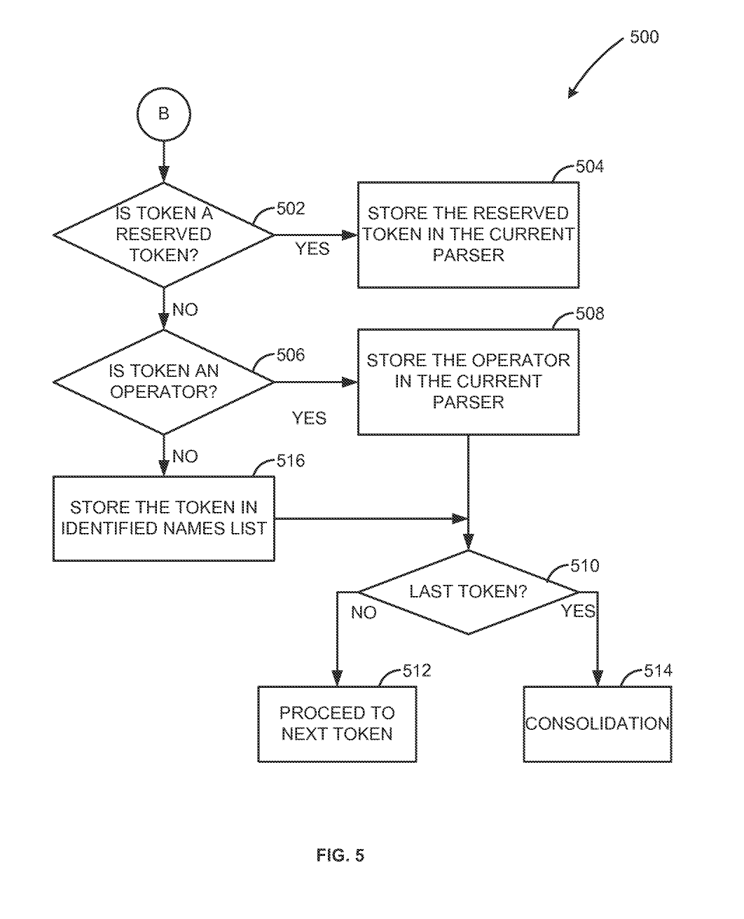

An embodiment of a procedure 400 related to function names is illustrated in FIG. 4. When an encountered token is not a keyword (as determined at 304 in FIG. 3), then the procedure moves to FIG. 4. At 402, a determination of whether the encountered keyword is an open parenthesis “(”. If the encountered keyword is not an open parenthesis “(”, then at 404 a subsequent procedure is used to determine the type of the token, as will be explained in reference to FIG. 5. If the encountered keyword is an open parenthesis “(”, then at 406 a token immediately before the open parenthesis is stored as a function name in the current parser. At 408, a determination of whether a token next to the open parenthesis “(” is a closed parenthesis “)”. When the next token is a closed parenthesis “)”, query traversing process moves to next token 410 and starts from step 302 of FIG. 3.

When the next token is not a closed parenthesis “)”, at 412 a determination of whether the next token is followed by another open parenthesis. When the next token is not followed by another open parenthesis but followed by a closed parenthesis, then at 414 that token is stored as an argument for the function name in the current parser. In the above COUNT (1) example, the token next to the open parenthesis is “1”, which is not followed by another open parenthesis but followed by a closed parenthesis. Therefore, the token “1” is stored as an argument for the function name “COUNT” in the SELECT parser. The token “1” is encountered immediately after the open parenthesis and before a closed parenthesis and is therefore an argument of the function “COUNT”. The process then moves to step 408.

In one embodiment, there can be nested functions such as “FUNCTION_{—}1 (FUNCTION_{—}2 ( ))”. In this example, the next token to the open parenthesis is “FUNCTION_{—}2” which is followed by another open parenthesis but not followed by a closed parenthesis. In such cases, the process moves to step 406 and “FUNCTION_{—}2” is stored as another function in the current parser. This process is repeated until all the nested functions are identified and stored.

An embodiment of a procedure 400 related to reserved tokens and operators is illustrated in FIG. 5. When an encountered token is not a keyword or an open parenthesis (as determined at 404 in FIG. 4), then the procedure moves to FIG. 5. The SQL language has a set of reserved words. At 502 a determination of whether the token is a reserved word in the SQL language of the first database. If the token is a reserved token, then the reserved token is stored in the current parser at 504. For example, consider that a SELECT statement includes “JOIN” token. When a “JOIN” token is encountered after creation of SELECT parser, then the “JOIN” token is stored in the SELECT parser.

If the encountered token is not a reserved token, then a determination of whether the token is an operator such as “+”, “−”, or “=”, etc., is made at 506. If the token is an operator, then the operator is stored in the current parser at 508. Considering the previously cited query, the WHERE statement include “=” operator. Therefore, when “=” operator token is encountered after creation of WHERE parser, then the “=” operator is stored in the WHERE parser. If the token is not an operator, then at 516 the token is stored in an “identified names” list in the current parser. This token that is added to the list can be a table name, a column name, or other tokens that are not keywords, function names, arguments, reserved tokens, and operators.

In one embodiment, in addition to table names and column names, alias names of the table names are also stored in the current parser. In some cases, a table or a column can be given an alias name. This can be useful when the table or column name is long or complex. The alias names are captured when “AS” token is encountered during traversing of the SQL query. In the above SQL query example, once the SELECT parser is created, the query is traversed to find the table names and the column names. When an “AS” token is encountered after a table name or a column name is encountered, then a token after the “AS” token is stored as the alias name for the respective table name or column name. When “AS” token is encountered after the column name “CITY_NAME”, the token after the “AS” token, i.e., “City”, is added to the SELECT parser as the alias name for the column name “CITY_NAME”.

Therefore, data stored in a parser includes one or more of table names, column names, alias names, function names, and arguments. A determination of whether the token is the last token of query is made at 510. If the token is not the last token, then the query traversing process moves to next token 512 and starts from step 302 of FIG. 3. If the token is the last token, the procedure moves to consolidation phase at 514 as will be explained below.

Following the procedure described above, depending on the SQL query, a plurality of parsers are created and data such as such as table names, column names, alias names, function names, reserved words, and operators are stored in respective parsers. For example, if the query has the keywords SELECT, FROM, WHERE, ORDERBY, and GROUPBY, then SELECT parser, FROM parser, WHERE parser, ORDERBY parser, and GROUPBY parser are created and associated data is stored in respective parsers. Suitable data structures can be used to store data related to a parser.

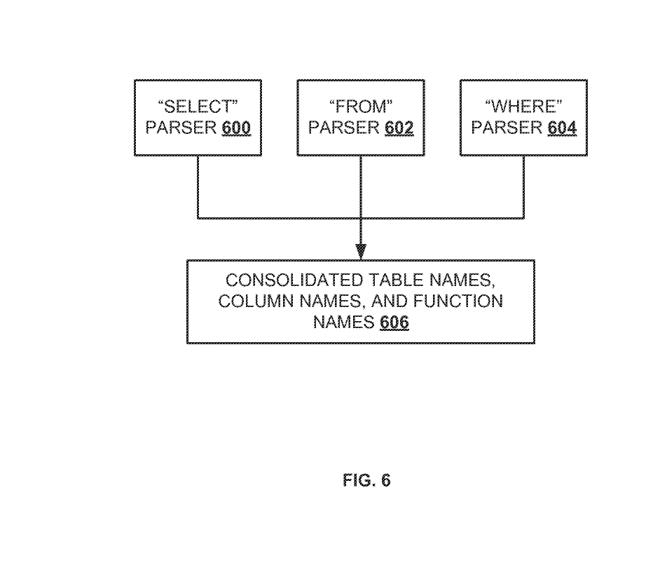

Referring back to FIG. 2, at 208, table names, column names, alias names, and function names of a plurality of parsers are consolidated. In one embodiment, this consolidation phase is performed after query traversing and parser creation is completed for an SQL query and the data associated with respective keywords is stored in respective parsers. Considering the SQL query example presented previously, the SELECT parser 600. FROM parser 602, and WHERE parser 604 are created as illustrated in FIG. 6. The table names, column names, and function names of these parsers are then consolidated 606. Data stored in the SELECT parser is presented in Table 2 below, as an example:

```
TABLE 2
{table_name: CITY,
  alias_name: null,
  list of <COLUMN>:[{column_name: CITY_NAME, alias_name:
  City]”
{table_name: COUNTRY,
  alias_name: null,
  list of <COLUMN>:[{column_name: COUNTRY_NAME, alias_name:
  Country]}
Function: {Count(1)}
```

Data stored in the FROM parser is presented in Table 3 below, as an example:

TABLE 3

{table_name: CITY, alias_name: CT}
{table_name: COUNTRY, alias_name: CY}

Data stored in the WHERE parser is presented in Table 4 below, as an example:

```
TABLE 4
{table_name: CITY,
  alias_name: null,
  list of <COLUMN>:[{column_name: CITY_NAME, alias_name:
  null]}
{table_name: COUNTRY,
  alias_name: null,
  list of <COLUMN>:[{column_name: COUNTRY_NAME, alias_name:
  null]}
Function: null
```

The above data of the parsers is consolidated by merging common table names, common column names, alias names, and common function names. If multiple parsers share a “TABLE_NAME” data structure with same table name and alias name, then they are consolidated to form one “TABLE_NAME” data. Similarly, the common column names and alias names are also merged and respective table names are assigned to the merged column names. The functions from the parsers are also consolidated to form a single list of functions. The result of consolidation of data of the SELECT parser 600, FROM parser 602, and WHERE parser 604 is presented in Table 5 below, as an example:

```
TABLE 5
{table_name: CITY,
  alias_name: CT,
  list of <COLUMN>:{[column_name: CITY_NAME, alias_name:
  City]}
{table_name: COUNTRY,
  alias_name: CY,
  list of <COLUMN>:[{column_name: COUNTRY_NAME, alias_name:
  Country]}
Function: Count(1)
```

In one embodiment, for nested SQL queries, the nested queries are split into individual queries. Each individual query is then processed as explained previously, i.e., creating parsers, storing data associated with keywords in respective parsers, and storing function names in respective parsers. For example, consider the following nested query including two sub-queries:

Select NAME from EMPLOYEE where EMP_ID in (select ID from
EMPLOYEE_REFERAL) and EMP_TYPE in (select TYPE from
EMPLOYEE_TYPE
where MODE = “Permanent”)

The first sub-query from the above query is presented below:

select ID from EMPLOYEE_REFERAL

The second sub-query is presented below:

select TYPE from EMPLOYEE TYPE where MODE=“Permanent”

A unique identifier is assigned to each sub-query. In one embodiment, “count” identifier is assigned to sub-queries. For example, $$$1 is assigned for the first sub-query and $$$2 is assigned for the second sub-query. The parent query then reads as below:

Select NAME from EMPLOYEE where EMP_ID in ($$$1) and EMP_TYPE in ($$$2)

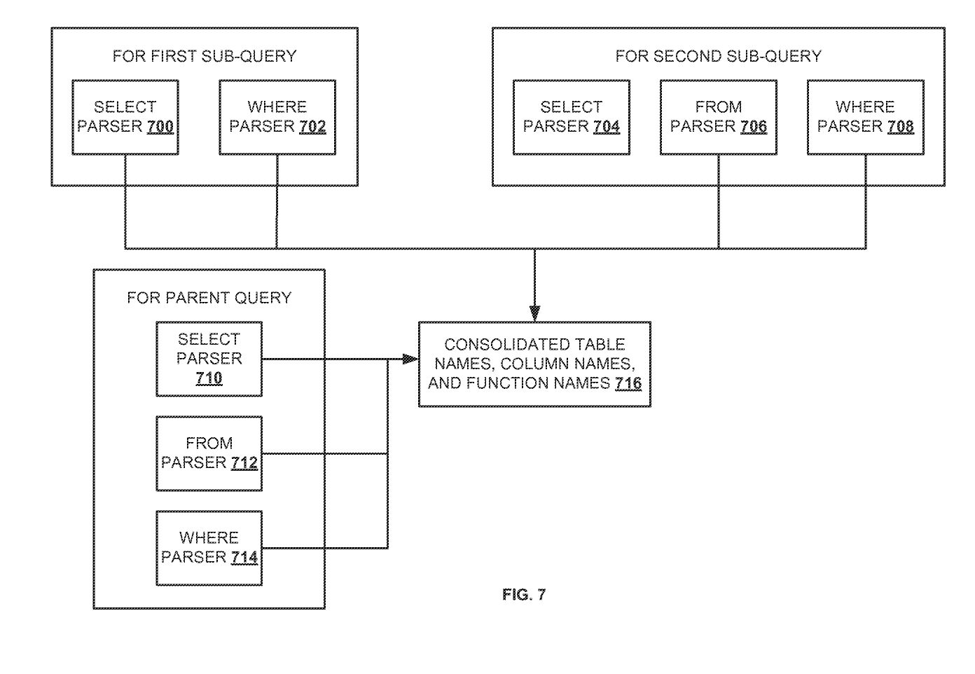

Therefore, there are now three individual queries, i.e., the parent query, the first sub-query, and the second sub-query. Each individual query is then processed and parsers are created for each individual query and data of keywords is stored in respective parsers. Referring to FIG. 7, SELECT parser 700 and WHERE parser 702 are created for the first sub-query, SELECT parser 704, FROM parser 706, and WHERE parser 708 are created for the second sub-query, and SELECT parser 710, FROM parser 712, and WHERE parser 714 are created for the parent query. The parsers of the individual queries are then consolidated at 716. For consolidation, the identifiers $$$1 and $$$2 will act as a key to identify the first and second sub-queries. The data of parsers is consolidated by merging common table names, common column names, alias names, and common function names of the parsers of the parent query, the first sub-query, and the second sub-query. The result of consolidation is stored in a data structure similar to Table 5 presented previously.

Referring back to FIG. 2, in one embodiment, after consolidation, one or more one or more table names, column names, and function names are replaced at 210 to make them compatible with SQL-syntax of a second database. Depending on the type of syntax of the first database, the SQL-syntax of the table names, column names, alias names, and function names may be incompatible with the SQL-syntax of the second database. For example, the SQL-syntax of the first database may not be case sensitive, while the SQL-syntax of the second database may be case sensitive. Therefore, queries in the first database may have been written without giving attention to the case. For example, consider the previous example of SQL-query:

SELECT Count(1), CITY.CITY_NAME AS City,
COUNTRY.COUNTRY_NAME AS Country
FROM CITY AS CT, COUNTRY AS CY
WHERE CITY.COUNTRY_ID = COUNTRY.COUNTRY_ID

The alias names “City” and “Country” include a mix of lower and upper case alphabets. This can be compatible with the first database as it is not case sensitive. But the second database being case sensitive may require alias names, table names, and column names in upper case. Therefore, “City” and “Country” are replaced with “CITY” and “COUNTRY”. Also, the SQL-syntax of the same type of functions may be different for the first and the second databases. For example, the “count” function name has the syntax “Count(1)” in the first database, whereas the same “count” function name has the syntax “CNT(1)” in the second or target database. Therefore, “Count(1)” is replaced with target function name “CNT(1)”. In one embodiment, the function names of the first database, the second database, and various other databases are stored in a file (e.g., XML file). This file is read to determine the replacement names for the functions.

At 212, a result including the consolidated table names, column names, alias names, function names, and any replaced names is generated. The result for the above example query is presented in Table 6 below:

```
TABLE 6
{table_name: CITY,
  alias_name: CT,
  list of <COLUMN>:{[column_name: CITY_NAME, alias_name:
  CITY]}
{table_name: COUNTRY,
  alias_name: CY,
  list of <COLUMN>:[{column_name: COUNTRY_NAME,
  alias_name: COUNTRY]}
First Database Function: Count(1)
Second Database Function: CNT(1)
```

It can be noted from the Table 6 that “CITY” and “COUNTRY” are in upper case and function name “Count( )” and replaced function name “CNT(1)” are part of the result. In one embodiment, the query parsing and translation is implemented by creating libraries in a programming language (e.g., object oriented programming language) and these libraries can be used by any application that supports the programming language.

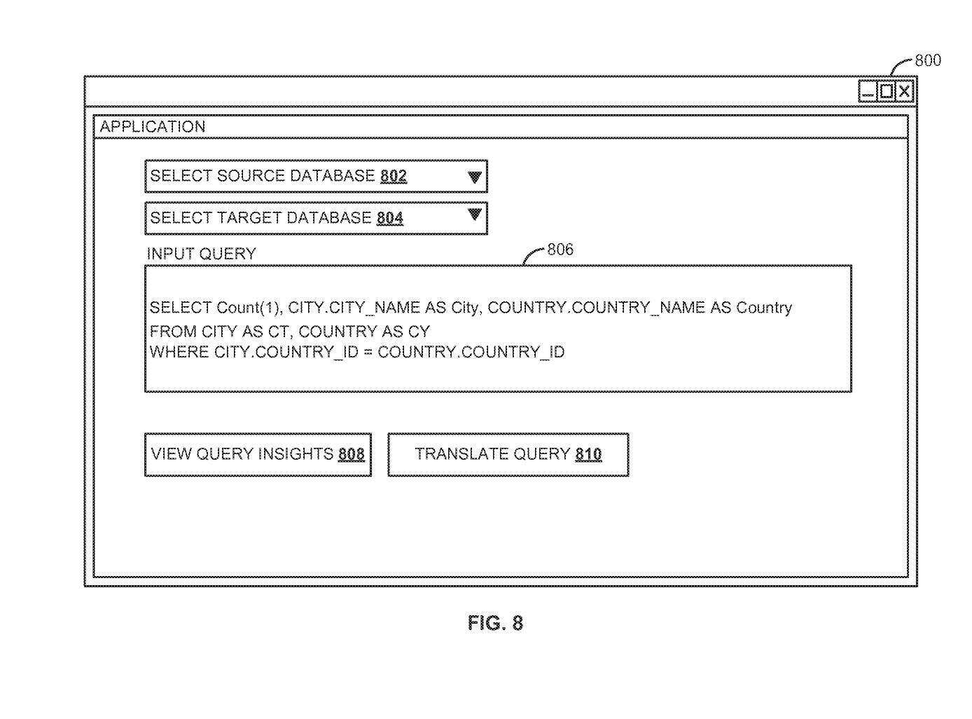

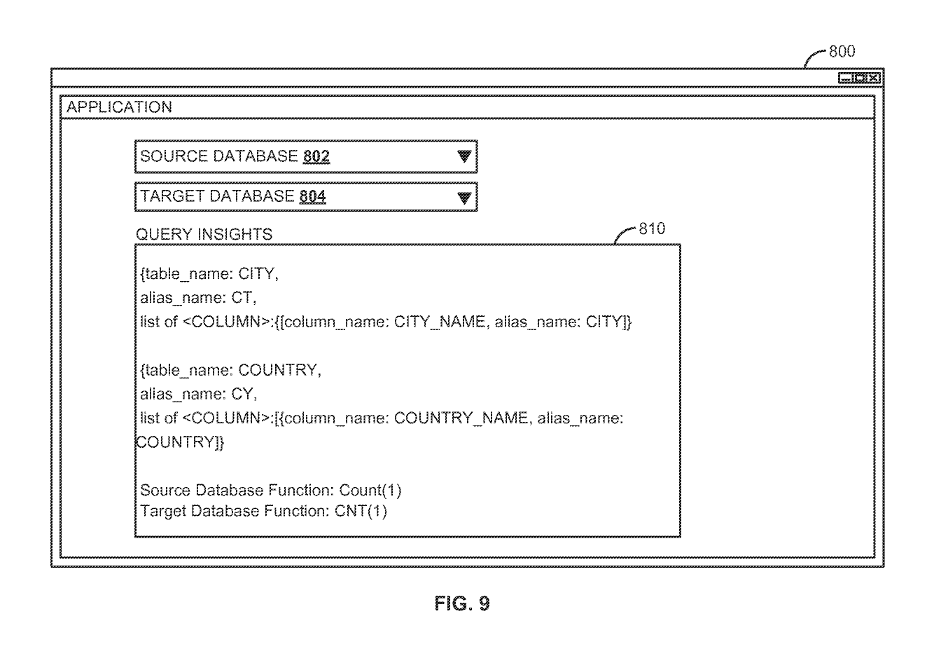

FIG. 8 illustrates an embodiment of a user interface 800 of a query parsing and translation application, which enables migration from a source or first database to a target or second database. A user can select source and target database using the source and target database selection fields 802 and 804. In one embodiment, a dropdown menu can be provided in the selection fields 802 and 804 to select the databases. The query of the source database can be provided in the input query field 806. As an example, previously presented SQL query is shown in the input query field 806. The user interface includes a query insights option 808 and a translate query option 810. Upon selection of query insights option 808, the result including the consolidated table names, consolidated column names, consolidated alias names, consolidated function names, and any replaced names is displayed on the user interface in the query insights field 812, as shown in FIG. 9.

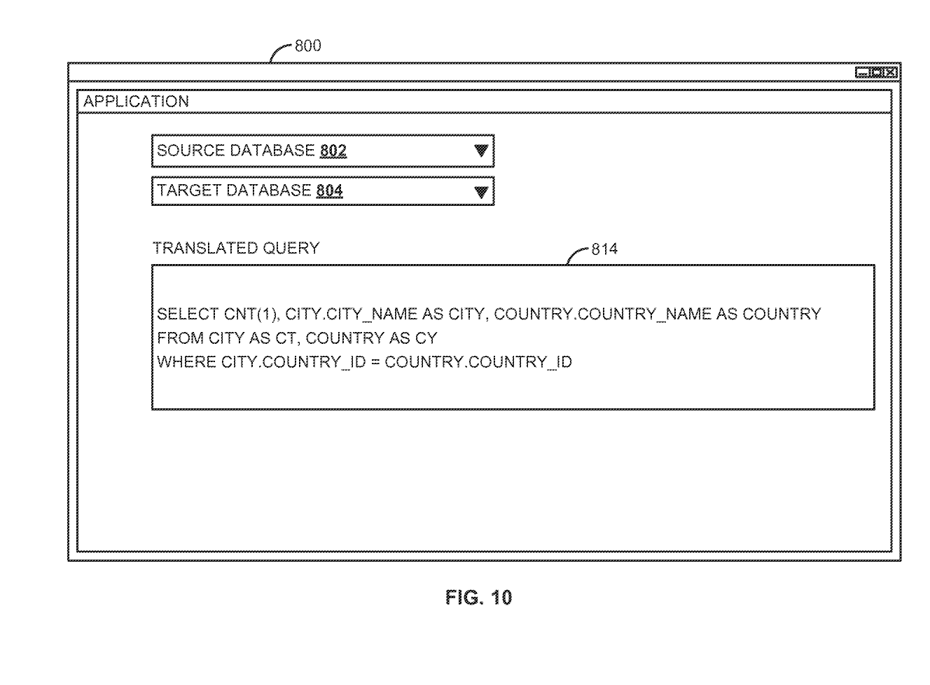

Upon selection of translate query option 810 (FIG. 8), the input query is translated into a translated query that is compatible with SQL-syntax of the target database. The translated query is displayed on the user interface in the translated query field 814, as shown in FIG. 10. The translated query is generated based on the data stored in the parsers and the replaced names. During the translation, reserved tokens, operators, and any other tokens are referred from the input query. The data stored in a parser includes table names, column names, alias names, functions, and arguments.

Embodiments described above automate the process of parsing SQL queries and translating the SQL queries of one database for compatibility with another type of SQL syntax. This will drastically reduce manual effort in database migration or any migration of applications that are built using database entities. Query insights provide a quick overview of the query to users, especially in the case of complex queries. Function names are automatically replaced with compatible ones and case-incompatible tokens are automatically replaced with case-compatible tokens, without any manual effort. Therefore, the translated query is made compatible with the SQL syntax of the target database.

In a first example, a computer system for SQL query translation includes a computer memory to store program code and a processor to execute the program code to split a structured query language (SQL) query of a first database into tokens and traverse the query from a first token; when a keyword token is encountered, create a current parser to store a table name and a column name associated with the encountered keyword token; when an open parenthesis is encountered, store a token immediately preceding the open parenthesis as a function name in the current parser, wherein the function name is specific to the first database; consolidate table names, column names, and function names of a plurality of parsers; replace one or more of the table names, the column names, and the function names with corresponding names that are compatible with SQL-syntax of a second database; and generate a result comprising the consolidated table names, the consolidated column names, the consolidated function names, and replaced names.

In a second example, the program code to replace the function names further comprises program code to replace the function name with a target function name specific to a second database.

In a third example, the program code to replace the table names and the column names further comprises program code to replace the table names and the column names with corresponding table names and column names that are case-compatible with SQL-syntax of the second database.

In a fourth example, the processor further executes the program code to generate a translated query compatible with SQL-syntax of the second database based on data stored in the plurality of parsers and the replaced names.

In a fifth example, the processor further executes the program code to display the result and the translated query on a user interface in response to user selections.

In a sixth example, the processor further executes the program code to store the token encountered immediately after the open parenthesis in the current parser as an argument name for the function name when a token is encountered immediately after the open parenthesis and before a closed parenthesis: when an operator associated with the keyword token is encountered, store the operator in the current parser; and when a reserved token associated with the keyword token is encountered, store the reserved token in the current parser.

In a seventh example, the processor further executes the program code to store alias names for the table names and the column names in the current parser and consolidate the alias names of the plurality of parsers.

In an eighth example, the processor further executes the program code to close a previous parser that is created for a previous keyword token when the keyword token is encountered.

In a ninth example, the processor further executes the program code to split the nested SQL queries into a plurality of individual queries when the SQL query is part of nested SQL queries and wherein the program code to consolidate the table names, the column names, and the function names of the plurality of parsers, further comprises program code to consolidate the table names, the column names, and the function names of the plurality of parsers of the individual queries.

In a tenth example, the program code to consolidate table names, column names, and function names of a plurality of parsers of the SQL query, further comprises program code to merge common table names, common column names, and common function names.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape: optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

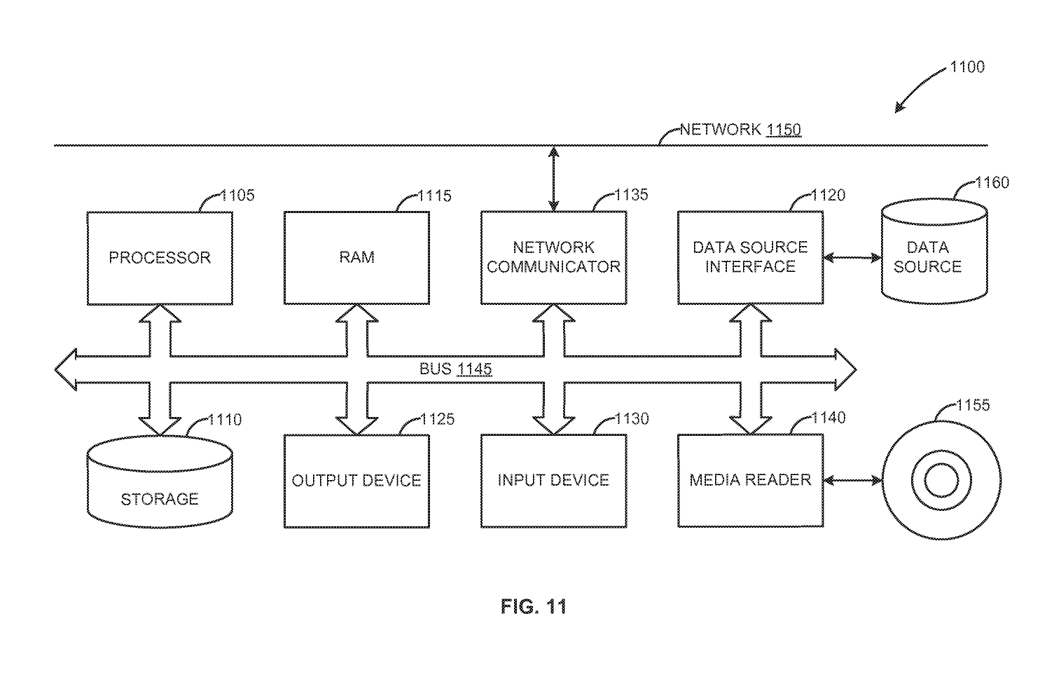

FIG. 11 is a block diagram of an exemplary computer system 1100. The computer system 1100 includes a processor 1105 that executes software instructions or code stored on a computer readable storage medium 1155 to perform the above-illustrated methods. The processor 1105 can include a plurality of cores. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. According to some embodiments, such as some in-memory computing system embodiments, the RAM 1115 can have sufficient storage capacity to store much of the data required for processing in the RAM 1115 instead of in the storage 1110. In some embodiments, all of the data required for processing may be stored in the RAM 1115. The stored instructions may be further compiled to generate other representations of the instructions and dynamically stored in the RAM 1115. The processor 1105 reads instructions from the RAM 1115 and performs actions as instructed. According to one embodiment, the computer system 1100 further includes an output device 1125 (e.g., a display) to provide at least some of the results of the execution as output including, but not limited to, visual information to users and an input device 1130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g. text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
split a structured query language (SQL) query of a first database into tokens and traverse the query from a first token;
when a keyword token is encountered, create a current parser to store a table name and a column name associated with the encountered keyword token;
when an open parenthesis is encountered, store a token immediately preceding the open parenthesis as a function name in the current parser, wherein the function name is specific to the first database;
consolidate table names, column names, and function names of a plurality of parsers;
replace one or more of the table names, the column names, and the function names with corresponding names that are compatible with SQL-syntax of a second database; and
generate a result comprising the consolidated table names, the consolidated column names, the consolidated function names, and replaced names.

2. The article of manufacture of claim 1, wherein the instructions to replace the function names further comprise instructions, which when executed by the computer, cause the computer to:
replace the function name with a target function name specific to a second database.

3. The article of manufacture of claim 2, wherein the instructions to replace the table names and the column names further comprises instructions, which when executed by the computer, cause the computer to:
replace the table names and the column names with corresponding table names and column names that are case-compatible with SQL-syntax of the second database.

4. The article of manufacture of claim 3, further comprising instructions which when executed by the computer, cause the computer to:
generate a translated query compatible with SQL-syntax of the second database based on data stored in the plurality of parsers and the replaced names.

5. The article of manufacture of claim 4, further comprising instructions which when executed by the computer, cause the computer to:
in response to user selections, display the result and the translated query on a user interface.

6. The article of manufacture of claim 1, further comprising instructions which when executed by the computer, cause the computer to:
when a token is encountered immediately after the open parenthesis and before a closed parenthesis, store the token encountered immediately after the open parenthesis in the current parser as an argument name for the function name;
when an operator associated with the keyword token is encountered, store the operator in the current parser; and
when a reserved token associated with the keyword token is encountered, store the reserved token in the current parser.

7. The article of manufacture of claim 1, further comprises instructions, which when executed by the computer, cause the computer to:
store alias names for the table names and the column names in the current parser; and
consolidate the alias names of the plurality of parsers.

8. The article of manufacture of claim 1, further comprises instructions, which when executed by the computer, cause the computer to:
when the keyword token is encountered, close a previous parser that is created for a previous keyword token.

9. The article of manufacture of claim 1, further comprises instructions, which when executed by the computer, cause the computer to:
when the SQL query is part of nested SQL queries, split the nested SQL queries into a plurality of individual queries; and
wherein the instructions to consolidate the table names, the column names, and the function names of the plurality of parsers, further comprise instructions, which when executed by the computer, cause the computer to:
consolidate the table names, the column names, and the function names of the plurality of parsers of the individual queries.

10. The article of manufacture of claim 1, wherein the instructions to consolidate table names, column names, and function names of a plurality of parsers of the SQL query, further comprises instructions, which when executed by a computer, cause the computer to:
merge common table names, common column names, and common function names.

11. A computer-implemented method for SQL query translation, the method comprising:
splitting a structured query language (SQL) query of a first database into tokens and traverse the query from a first token;
when a keyword token is encountered, creating a current parser to store a table name and a column name associated with the encountered keyword token;
when an open parenthesis is encountered, storing a token immediately preceding the open parenthesis as a function name in the current parser, wherein the function name is specific to the first database;
consolidating table names, column names, and function names of a plurality of parsers;
replacing one or more of the table names, the column names, and the function names with corresponding names that are compatible with SQL-syntax of a second database; and
generating a result comprising the consolidated table names, the consolidated column names, the consolidated function names, and replaced names.

12. The method of claim 11, wherein replacing the function names further comprising:
replacing the function name with a target function name specific to a second database.

13. The method of claim 12, wherein replacing the table names and the columns names further comprising:
replacing the table names and the column names with corresponding table names and column names that are case-compatible with SQL-syntax of the second database.

14. The method of claim 13, further comprising:
generating a translated query compatible with SQL-syntax of the second database based on data stored in the plurality of parsers and the replaced names.

15. The method of claim 14, further comprising:
in response to user selections, displaying the result and the translated query on a user interface.

16. The method of claim 11, further comprising:
when a token is encountered immediately after the open parenthesis and before a closed parenthesis, storing the token encountered immediately after the open parenthesis in the current parser as an argument name for the function name;
when an operator associated with the keyword token is encountered, storing the operator in the current parser; and
when a reserved token associated with the keyword token is encountered, storing the reserved token in the current parser.

17. The method of claim 11, further comprising:
storing alias names for the table names and the column names in the current parser; and
consolidating the alias names of the plurality of parsers.

18. The method of claim 11, further comprising:
when the keyword token is encountered, closing a previous parser that is created for a previous keyword token.

19. The method of claim 11, further comprising:
when the SQL query is part of nested SQL queries, splitting the nested SQL queries into a plurality of individual queries; and
wherein consolidating the table names, the column names, and the function names of the plurality of parsers, further comprising:
consolidating the table names, the column names, and the function names of the plurality of parsers of the individual queries.

20. The method of claim 11, wherein consolidating table names, column names, and function names of a plurality of parsers of the SQL query, further comprising:
merging common table names, common column names, and common function names.

21. A computer system for SQL query translation, comprising:
a computer memory to store program code; and
a processor to execute the program code to:
split a structured query language (SQL) query of a first database into tokens and traverse the query from a first token;
when a keyword token is encountered, create a current parser to store a table name and a column name associated with the encountered keyword token;
when an open parenthesis is encountered, store a token immediately preceding the open parenthesis as a function name in the current parser, wherein the function name is specific to the first database;
consolidate table names, column names, and function names of a plurality of parsers;
replace one or more of the table names, the column names, and the function names with corresponding names that are compatible with SQL-syntax of a second database; and
generate a result comprising the consolidated table names, the consolidated column names, the consolidated function names, and replaced names.
